(19) United States
(12) Patent Application Publication
(10) Pub. No.: US 2014/0280575 A1
(43) Pub. Date: Sep. 18, 2014

(54) DETERMINING ACTIVITIES RELEVANT TO USERS

(71) Applicant: Google Inc., Mountain View, CA (US)

(72) Inventor: Mathew COWAN, New York, NY (US)

(21) Appl. No.: 13/928,950

(22) Filed: Jun. 27, 2013

Related U.S. Application Data
(60) Provisional application No. 61/784,418, filed on Mar. 14, 2013.

(51) Int. Cl. H04L 29/08

(52) U.S. Cl. CPC H04L 67/22
USPC 709/204

(57) ABSTRACT

A system is configured to receive profile data for a user. The profile data may include user attributes. The profile data may include information regarding time intervals during which the user is available. The system is configured to receive a set of activity identifiers that identify activities in which the user can participate. Each of the activities may be associated with activity attributes. The activity attributes may identify one or more points in time at which the activity will occur. The system is configured to determine a correlation score for each activity of the activities. The correlation score for the activity may be determined from a correlation between the activity attributes associated with the activity and the profile data for the user. The system is configured to notify the user about one or more of the activities based on the correlation scores for the one or more activities.

### RELATED APPLICATION

This application is a non-provisional of U.S. Provisional Application No. 61/784,418, filed Mar. 14, 2013, the contents of which are incorporated herein by reference.

### BACKGROUND

This specification relates generally to activity planning in the context of digital information retrieval.

Individuals plan activities to stay organized and pursue activities that are of interest to them. Activity planning can be a manual and time consuming process. For example, to plan an activity, individuals perform research on the different available activities, determine which activities they are interested in, determine if they are free at the points in time that the activities will occur, and perform the necessary steps to participate in the activity, e.g., purchase tickets for a concert or make reservations for a meal at a restaurant.

User devices, e.g., cell phones, tablets, personal assistant devices, computers, etc., provide users with information. Users can request specific information that is of interest to the users. For example, users can request information about upcoming activities, as well as any Internet accessible information from their user devices. User devices also provide notifications to users. For example, a user device can notify a user about upcoming activities.

### SUMMARY

This specification describes technologies relating to determining activities relevant to users in which the users can participate.

According to some possible implementations, a method, performed by one or more computer devices, may include receiving profile data for a user, where the profile data may include user attributes, and where the profile data may include information regarding time intervals during which the user is available; receiving a set of activity identifiers that identify activities in which the user can participate, where each of the activities may be associated with activity attributes, and where the activity attributes may identify one or more points in time at which the activity will occur; determining a correlation score for each activity of the activities, where the correlation score for the activity may be determined from a correlation between the activity attributes associated with the activity and the profile data for the user; and notifying the user about one or more of the activities based on the correlation scores for the one or more activities.

According to some possible implementations, the method may further include determining that the one or more points in time at which the activity will occur coincide with the time intervals.

According to some possible implementations, the method may further include determining a confidence score for each of the user attributes, where determining the correlation score for each activity may include determining the correlation score from the confidence scores for the user attributes that correlate with one or more of the activity attributes associated with the activity.

According to some possible implementations, the method may further include determining that the correlation score for each of the one or more activities satisfies a threshold.

According to some possible implementations, notifying the user about the one or more activities may include providing, for presentation, one or more notification objects, where the one or more notification objects may identify the one or more activities in an order based on the correlation score for each of the one or more activities.

According to some possible implementations, notifying the user about the one or more activities may include automatically scheduling the one or more activities in a calendar associated with the user.

According to some possible implementations, a system may include one or more computers to: receive profile data for a user, where the profile data may include user attributes identifying entities of interest to the user; receive a set of activity identifiers that identify activities in which the user can participate, where each of the activities may be associated with one or more activity attributes; determine a correlation score for each activity of the activities, where the correlation score for the activity may be determined from a correlation between the one or more activity attributes associated with the activity and the profile data for the user; select one or more of the activities that occur at points in time during which the user is available; and notify the user about the selected one or more activities based on the correlation scores for the selected one or more activities.

According to some possible implementations, the one or more computers, when selecting one or more of the activities that occur at points in time during which the user is available, may identify time intervals during which the user is available from a calendar associated with the user; and select the one or more activities that occur at points in time that coincide with the time intervals.

According to some possible implementations, the one or more computers may receive a confidence score for each of the user attributes, and where the one or more computers, when determining the correlation score for each activity, may determine the correlation score from the confidence scores for the user attributes that correlate with one or more of the activity attributes associated with the activity.

According to some possible implementations, the one or more computers may determine that the correlation score for each of the one or more activities satisfies a threshold.

According to some possible implementations, the one or more computers, when notifying the user about the selected one or more activities, may provide, for presentation, one or more notification objects, where the one or more notification objects may identify the selected one or more activities in an order based on the correlation score for each of the selected one or more activities.

According to some possible implementations, the one or more computers, when notifying the user about the selected one or more activities, may schedule the selected one or more activities on a calendar associated with the user.

According to some possible implementations, the one or more computers, when notifying the user about the selected one or more activities, may present, for display, a notification object describing one of the selected one or more activities, where the notification object may include an option for creating an entry, in a calendar associated with the user, relating to the one of the selected one or more activities; and create the entry in the calendar based on selection of the option.

According to some possible implementations, a computer storage medium may store instructions, where the instructions may include a set of instructions which, when executed by one or more processors, cause the one or more processors to: receive profile data for a user, where the profile data may include user attributes, and where the profile data may include information regarding time intervals during which the user is available; receive a set of activity identifiers that identify activities in which the user can participate, where each of the activities may be associated with activity attributes, and where the activity attributes may identify one or more points in time at which the activity will occur; determine a correlation score for each activity of the activities, where the correlation score for the activity may be determined from a correlation between the activity attributes associated with the activity and the profile data for the user; and notify the user about one or more of the activities based on the correlation scores for the one or more activities.

According to some possible implementations, the set of instructions which, when executed by the one or more processors, further cause the one or more processors to determine that the one or more points in time at which the activity will occur coincide with the time intervals.

According to some possible implementations, the set of instructions which, when executed by the one or more processors, further cause the one or more processors to determine a confidence score for each of the user attributes, and where one or more instructions, of the set of instructions, to determine the correlation score for each activity include one or more instructions to determine the correlation score from the confidence scores for the user attributes that correlate with one or more of the activity attributes associated with the activity.

According to some possible implementations, the set of instructions which, when executed by the one or more processors, further cause the one or more processors to determine that the correlation score for each of the one or more activities satisfies a threshold.

According to some possible implementations, where one or more instructions, of the set of instructions, to notify the user about the one or more activities may include one or more instructions to present, for display, one or more notification objects, where the one or more notification objects may identify the one or more activities in an order based on the correlation score for each of the one or more activities.

According to some possible implementations, where one or more instructions, of the set of instructions, to notify the user about the one or more activities may include one or more instructions to schedule the one or more activities in a calendar associated with the user.

According to some possible implementations, the set of instructions which, when executed by the one or more processors, further cause the one or more processors to identify the time intervals during which the user is available from a calendar associated with the user; and select at least one of the one or more activities for which the activity attributes identify a point in time that coincides with the time intervals.

According to some possible implementations, a system may include means for receiving profile data for a user, where the profile data may include user attributes, and where the profile data may include information regarding time intervals during which the user is available; means for receiving a set of activity identifiers that identify activities in which the user can participate, where each of the activities may be associated with activity attributes, and where the activity attributes may identify one or more points in time at which the activity will occur; means for determining a correlation score for each activity of the activities, where the correlation score for the activity may be determined from a correlation between the activity attributes associated with the activity and the profile data for the user; and means for notifying the user about one or more of the activities based on the correlation scores for the one or more activities.

The above discussion mentions examples in which some implementations may be implemented via one or more methods performed by one or more processors of one or more devices. In some implementations, one or more systems and/or one or more devices may be configured to perform one or more of the acts mentioned above. In some implementations, a computer-readable medium may include computer-executable instructions which, when executed by one or more processors, cause the one or more processors to perform one or more of the acts mentioned above.

### BRIEF DESCRIPTION OF THE DRAWINGS

FIG. 1 illustrates an example knowledge graph containing nodes and edges.

FIG. 2 illustrates an example knowledge graph portion.

FIG. 3 illustrates another example knowledge graph portion.

FIG. 4 illustrates an example activity correlation system.

FIG. 5 illustrates an example method for determining activities relevant to users.

FIG. 6 illustrates an example correlation between activity attributes associated with activities and the profile data for a user.

FIG. 7A-7D illustrate example graphical user interfaces for notifying users about relevant activities.

Like reference numbers and designations in the various drawings indicate like elements.

### DETAILED DESCRIPTION

The subject matter described in this specification can be implemented in particular embodiments so as to realize one or more of the following advantages. Activities of interest to users can be determined. The users can be automatically notified about the activities in which the users can participate. The activities can be scheduled for the users at a time when the user is free to participate in the activity.

In some implementations, data may be organized in a database using any one or more data structuring techniques. For example, data may be organized in a graph containing nodes connected by edges. In some implementations, the data may include statements about relationships between things and concepts, and those statements may be represented as nodes and edges of a graph. The nodes each contain a piece or pieces of data and the edges represent relationships between the data contained in the nodes that the edges connect. In some implementations, the graph includes one or more pairs of nodes connected by an edge. The edge, and thus the graph, may be directed, i.e. unidirectional, undirected, i.e. bidirectional, or both, i.e. one or more edges may be undirected and one or more edges may be directional in the same graph. Nodes may include any suitable data or data representation. Edges may describe any suitable relationships between the data. In some implementations, an edge is labeled or annotated, such that the edge includes both the connection between the nodes, and descriptive information about that connection. A particular node may be connected by distinct edges to one or more other nodes, or to itself, such that an extended graph is formed. For purposes of clarity, a graph based on the structure described immediately above is referred to herein as a knowledge graph. In some implementations, the knowledge graph may be a useful for representing information and in providing information in search.

FIG. 1 illustrates an example knowledge graph 100 containing nodes and edges. Illustrative knowledge graph 100 includes nodes 102, 104, 106, and 108. Knowledge graph 100 includes edge 110 connecting node 102 and node 104. Knowledge graph 100 includes edge 112 connecting node 102 and node 106. Knowledge graph 100 includes edge 114 connecting node 104 and node 108. Knowledge graph 100 includes edge 116 and edge 118 connecting node 102 and node 108. Knowledge graph 100 includes edge 120 connecting node 108 to itself. Each aforementioned group of an edge and one or two distinct nodes may be referred to as a triple or 3-tuple. As illustrated, node 102 is directly connected by edges to three other nodes, while nodes 104 and 108 are directly connected by edges to two other nodes. Node 106 is connected by an edge to only one other node, and in some implementations, node 106 is referred to as a terminal node. As illustrated, nodes 102 and 108 are connected by two edges, indicating that the relationship between the nodes is defined by more than one property. As illustrated, node 108 is connected by edge 120 to itself, indicating that a node may relate to itself. While illustrative knowledge graph 100 contains edges that are not labeled as directional, it will be understood that each edge may be unidirectional or bidirectional. It will be understood that this example of a graph is merely an example and that any suitable size or arrangement of nodes and edges may be employed.

Generally, nodes in a knowledge graph can be grouped into several categories. Nodes may represent entities, organizational data such as entity types and properties, literal values, and models of relationships between other nodes.

In some implementations, entity types, properties, and other suitable content is created, defined, redefined, altered, or otherwise generated by any suitable technique. For example, content may be generated by manual user input, by automatic responses to user interactions, by importation of data from external sources, by any other suitable technique, or any combination thereof. For example, if a commonly searched for term is not represented in the knowledge graph, one or more nodes representing that node may be added. In another example, a user may manually add information and organizational structures.

A node of a knowledge graph may represent an entity. An entity is a thing or concept that is singular, unique, well-defined and distinguishable. For example, an entity may be a person, place, item, idea, abstract concept, concrete element, other suitable thing, or any combination thereof. Nodes are unique, in that no two nodes refer to the same thing or concept. Generally, entities include things or concepts represented linguistically by nouns. For example, the color “Blue,” the city “San Francisco,” and the imaginary animal “Unicorn” may each be entities. An entity generally refers to the concept of the entity. For example, the entity “New York City” refers to the physical city, and the knowledge graph uses a concept of the physical city as represented by, for example, an element in a data structure, the name of the entity, any other suitable element, or any combination thereof.

A node representing organizational data may be included in a knowledge graph. These may be referred to herein as entity type nodes. As used herein, an entity type node may refer to a node in a knowledge graph, while an entity type may refer to the concept represented by an entity type node. An entity type may be a defining characteristic of an entity. For example, entity type node Y may be connected to an entity node X by an “Is A” edge or link, discussed further below, such that the graph represents the information “The Entity X Is type Y.” For example, the entity node “George Washington” may be connected to the entity type node “President.” An entity node may be connected to multiple entity type nodes, for example, “George Washington” may also be connected to entity type node “Person” and to entity type node “Military Commander.” In another example, the entity type node “City” may be connected to entity nodes “New York City” and “San Francisco.” In another example, the concept “Tall People,” although incompletely defined, i.e., it does not necessarily include a definition of “tall,” may exist as an entity type node. In some implementations, the presence of the entity type node “Tall People,” and other entity type nodes, may be based on user interaction.

In some implementations, an entity type node may include or be connected to data about: a list of properties associated with that entity type node, the domain to which that entity type node belongs, descriptions, values, any other suitable information, or any combination thereof. A domain refers to a collection of related entity types. For example, the domain “Film” may include, for example, the entity types “Actor,” “Director,” “Filming Location,” “Movie,” any other suitable entity type, or any combination thereof. In some implementations, entities are associated with types in more than one domain. For example, the entity node “Benjamin Franklin” may be connected with the entity type node “Politician” in the domain “Government” as well as the entity type node “Inventor” in the domain “Business.”

In some implementations, properties associated with entity nodes or entity type nodes may also be represented as nodes. For example, nodes representing the property “Population” or “Location” may be connected to the entity type node “City.” The combination and/or arrangement of an entity type and its properties is referred to as a schema. In some implementations, schemas are stored in tables or other suitable data structures associated with an entity type node. In some implementations, the knowledge graph may be self-defining or bootstrapping, such that it includes particular nodes and edges that define the concept of nodes, edges, and the graph itself. For example, the knowledge graph may contain an entity node “Knowledge Graph” that is connected to property nodes that describe a knowledge graph's properties such as “Has Nodes” and “Has Edges.”

Specific values, in some implementations referred to as literals, may be associated with a particular entity in a terminal node by an edge defining the relationship. Literals may refer to values and/or strings of information. For example, literals may include dates, names, and/or numbers. In an example, the entity node “San Francisco” may be connected to a terminal node containing the literal “815,000” by an edge annotated with the property “Has Population.” In some implementations, terminal nodes may contain a reference or link to long text strings and other information stored in one or more documents external to the knowledge graph. In some implementations, literals are stored as nodes in the knowledge graph. In some implementations, literals are stored in the knowledge graph but are not assigned a unique identification reference as described below, and are not capable of being associated with multiple entities. In some implementations, literal type nodes may define a type of literal, for example “Date/Time,” “Number,” or “GPS Coordinates.”

In some implementations, the grouping of an edge and two nodes is referred to as a triple. The triple represents the relationship between the nodes, or in some implementations, between the node and itself. In some implementations, higher order relationships are modeled, such as quaternary and n-ary relationships, where n is an integer greater than 2. In some implementations, information modeling the relationship is stored in a node, which may be referred to as a mediator node. In an example, the information “Person X Donates Artifact Y To Museum Z” is stored in a mediator node connected to entity nodes X, Y, and Z, where each edge identifies the role of each respective connected entity node.

In some implementations, the knowledge graph may include information for differentiation and disambiguation of terms and/or entities. As used herein, differentiation refers to the many-to-one situation where multiple names are associated with a single entity. As used herein, disambiguation refers to the one-to-many situation where the same name is associated with multiple entities. In some implementations, nodes may be assigned a unique identification reference. In some implementations, the unique identification reference may be an alphanumeric string, a name, a number, a binary code, any other suitable identifier, or any combination thereof. The unique identification reference may allow the system to assign unique references to nodes with the same or similar textual identifiers. In some implementations, the unique identifiers and other techniques are used in differentiation, disambiguation, or both.

In some implementations of differentiation, a node may be associated with multiple terms or differentiation aliases in which the terms are associated with the same entity. For example, the terms “George Washington,” “Geo. Washington, “President Washington,” and “President George Washington” may all be associated with a single entity, i.e., node, in the knowledge graph. This may provide differentiation and simplification in the knowledge graph.

In some implementations of disambiguation, multiple nodes with the same or similar names are defined by their unique identification references, by associated nodes in the knowledge graph, by any other suitable information, or any combination thereof. For example, there may be an entity node related to the city “Philadelphia,” an entity node related to the movie “Philadelphia,” and an entity node related to the cream cheese brand “Philadelphia.” Each of these nodes may have a unique identification reference, stored for example as a number, for disambiguation within the knowledge graph. In some implementations, disambiguation in the knowledge graph is provided by the connections and relationships between multiple nodes. For example, the city “New York” may be disambiguated from the state “New York” because the city is connected to an entity type “City” and the state is connected to an entity type “State.” It will be understood that more complex relationships may also define and disambiguate nodes. For example, a node may be defined by associated types, by other entities connected to the node by particular properties, by its name, by any other suitable information, or any combination thereof. These connections may be useful in disambiguating, for example, the node “Georgia” that is connected to the node “United States” may be understood to represent the U.S. State, while the node “Georgia” connected to the nodes “Asia” and “Eastern Europe” may be understood to represent the country in eastern Europe.

In some implementations, a node may include or connect to data defining one or more attributes. The attributes may define a particular characteristic of the node. The particular attributes of a node may depend on what the node represents. In some implementations, an entity node may include or connect to: a unique identification reference, a list of entity types associated with the node, a list of differentiation aliases for the node, data associated with the entity, a textual description of the entity, links to a textual description of the entity, other suitable information, or any combination thereof. As described above, nodes may contain a reference or link to long text strings and other information stored in one or more documents external to the knowledge graph. In some implementations, the storage technique may depend on the particular information. For example, a unique identification reference may be stored within the node, a short information string may be stored in a terminal node as a literal, and a long description of an entity may be stored in an external document linked to by a reference in the knowledge graph.

An edge in a knowledge graph may represent a semantic connection defining a relationship between two nodes. The edge may represent a prepositional statement such as “Is A,” “Has A,” “Is Of A Type,” “Has Property,” “Has Value,” any other suitable statement, or any combination thereof. For example, the entity node of a particular person may be connected by a “Date Of Birth” edge to a terminal node containing a literal of his or her specific date of birth. In some implementations, the properties defined by edge connections of an entity may relate to nodes connected to the type of that entity. For example, the entity type node “Movie” may be connected to entity nodes “Actor” and “Director,” and a particular movie may be connected by an edge property “Has Actor” to an entity node representing a particular actor.

In some implementations, nodes and edges define the relationship between an entity type node and its properties, thus defining a schema. For example, an edge may connect an entity type node to a node associated with a property, which may be referred to as a property node. Entities of the type may be connected to nodes defining particular values of those properties. For example, the entity type node “Person” may be connected to property node “Date of Birth” and a node “Height.” Further, the node “Date of Birth” may be connected to the literal type node “Date/Time,” indicating that literals associated with “Date of Birth” include date/time information. The entity node “George Washington,” which is connected to entity type node “Person” by an “Is A” edge, may also be connected to a literal “Feb. 22, 1732” by the edge “Has Date Of Birth.” In some implementations, the entity node “George Washington” is connected to a “Date Of Birth” property node. It will be understood that in some implementations, both schema and data are modeled and stored in a knowledge graph using the same technique. In this way, both schema and data can be accessed by the same search techniques. In some implementations, schemas are stored in a separate table, graph, list, other data structure, or any combination thereof. It will also be understood that properties may be modeled by nodes, edges, literals, any other suitable data, or any combination thereof.

For example, the entity node “George Washington” may be connected by an “Is A” edge to the entity type node representing “Person,” thus indicating an entity type of the entity, and may also be connected to a literal “Feb. 22, 1732” by the edge “Has Date Of Birth,” thus defining a property of the entity. In this way, the knowledge graph defines both entity types and properties associated with a particular entity by connecting to other nodes. In some implementations, “Feb. 22, 1732” may be a node, such that it is connected to other events occurring on that date. In some implementations, the date may be further connected to a year node, a month node, and a day node. It will be understood that this information may be stored in any suitable combination of literals, nodes, terminal nodes, interconnected entities, any other suitable arrangement, or any combination thereof.

FIG. 2 illustrates an example knowledge graph portion 200. Knowledge graph portion 200 includes information related to the entity “George Washington,” represented by “George Washington” node 202. “George Washington” node 202 is connected to “U.S. President” entity type node 204 by “Is A” edge 214 with the semantic content “Is A,” such that the 3-tuple defined by nodes 202 and 204 and the edge 214 contains the information “George Washington is a U.S. President.” Similarly, the information “Thomas Jefferson Is A U.S. President” is represented by the tuple of “Thomas Jefferson” node 210, “Is A” edge 220, and “U.S. President” node 204. Knowledge graph portion 200 includes entity type nodes “Person” 224, and “U.S. President” node 204. The person type is defined in part by the connections from “Person” node 224. For example, the type “Person” is defined as having the property “Date Of Birth” by node 230 and edge 232, and is defined as having the property “Gender” by node 234 and edge 236. These relationships define in part a schema associated with the entity type “Person.”

“George Washington” node 202 is shown in knowledge graph portion 200 to be of the entity types “Person” and “U.S. President,” and thus is connected to nodes containing values associated with those types. For example, “George Washington” node 202 is connected by “Has Gender” edge 218 to “Male” node 206, thus indicating that “George Washington has gender “Male.” Further, “Male” node 206 may be connected to the “Gender” node 234 indicating that “Male Is A Type Of Gender.” Similarly, “George Washington” node 202 is be connected by “Has Date of Birth” edge 216 to “Feb. 22, 1732” node 208, thus indicating that “George Washington Has Date Of Birth Feb. 22, 1732.” “George Washington” node 202 may also be connected to “1789” node 228 by “Has Assumed Office Date” edge 230.

Knowledge graph portion 200 also includes “Thomas Jefferson” node 210, connected by “Is A” edge 220 to entity type “U.S. President” node 204 and by “Is A” edge 228 to “Person” entity type node 224. Thus, knowledge graph portion 200 indicates that “Thomas Jefferson” has the entity types “U.S. President” and “Person.” In some implementations, “Thomas Jefferson” node 210 is connected to nodes not shown in FIG. 2 referencing his date of birth, gender, and assumed office date.

It will be understood that knowledge graph portion 200 is merely an example and that it may include nodes and edges not shown. For example, “U.S. President” node 204 may be connected to all of the U.S. Presidents. “U.S. President” node 204 may also be connected to properties related to the entity type such as a duration of term, for example “4 Years,” a term limit, for example “2 Terms,” a location of office, for example “Washington D.C.,” any other suitable data, or any combination thereof. For example, “U.S. President” node 204 is connected to “Assumed Office Date” node 238 by “Has Property” edge 240, defining in part a schema for the type “U.S. President.” Similarly, “Thomas Jefferson” node 210 may be connected to any suitable number of nodes containing further information related to his illustrated entity type nodes “U.S. President,” and “Person,” and to other entity type nodes not shown such as “Inventor,” “Vice President,” and “Author.” In a further example, “Person” node 224 may be connected to all entities in the knowledge graph with the type “Person.” In a further example, “1789” node 228 may be connected to all events in the knowledge graph with the property of year “1789.” “1789” node 228 is unique to the year 1789, and disambiguated from, for example, a book entitled “1789,” not shown in FIG. 2, by its unique identification reference. In some implementations, “1789” node 228 is connected to the entity type node “Year.”

FIG. 3 illustrates another example knowledge graph portion 300. Knowledge graph portion 300 includes “California” node 302, which may also be associated with differentiation aliases such as, for example, “CA,” “Calif.,” “Golden State,” any other suitable differentiation aliases, or any combination thereof. In some implementations, these differentiations are stored in “California” node 302. California is connected by “Is A” edge 304 to the “U.S. State” entity type node 306. “New York” node 310 and “Texas” node 314 are also connected to “U.S. State” node 306 by “Is A” edges 308 and 312, respectively. “California” node 302 is connected by “Has Capital City” edge 320 to “Sacramento” node 322, indicating the information that “California Has Capital City Sacramento.” Sacramento node 322 is further connected by “Is A” edge 324 to the “City” entity type node 326. Similarly, “Texas” node 314 is connected by “Has City” edge 320 to “Houston” node 328, which is further connected to the “City” entity type node 326 by “Is A” edge 340. “California” node 302 is connected by “Has Population” edge 316 to node 318 containing the literal value “37,691,912.” In an example, the particular value “37,691,912” may be periodically automatically updated by the knowledge graph based on an external website or other source of data. Knowledge graph portion 300 may include other nodes not shown. For example, “U.S. State” entity type node 306 may be connected to nodes defining properties of that type such as “Population” and “Capital City.” These type-property relationships may be used to define other relationships in knowledge graph portion 300 such as “Has Copulation” edge 316 connecting entity node “California” 316 with terminal node 318 containing the literal defining the population of California.

FIG. 4 illustrates an example activity correlation system 402 as can be implemented for use in an Internet, intranet, or another client and server environment. The activity correlation system 402 can be implemented as, for example, computer programs running on one or more computers in one or more locations that are coupled to each other through a network. The systems, components, and techniques described below can be implemented in the example activity correlation system 402.

The activity correlation system 402 includes an activity correlation score determiner 408 and an activity notifier 410. The activity correlation system 402 can communicate with a data source 412 through one or more wired or wireless networks, e.g., mobile phone networks, local area networks (LANs) or wide area networks (WANs), e.g., the Internet. In some implementations, data source 412 can be one or more data sources. For example, the activity correlation system 402 can communicate with one or more databases that contain data about one or more users. In some implementations, the activity correlation system 402 can receive profile data for users from data source 412. For example, the data source 412 can be one or more databases that contain entries for each of the one or more users. The database entry for a user includes profile data for the user. Each database entry for a user can be identified by a unique identifier, for example, a unique series of numbers or code. The profile data for a particular user can include user attributes for the particular user. User attributes for a user are qualities or features that are characteristics or inherent aspects of the user. User attributes can identify entities associated with the user, preferences of the user, and time intervals for when the user is available.

Entities associated with the user are entities that are of interest to the user. The entities can be of any entity type. Example entity types include movies, actors, music artists, songs, albums, concerts, authors, TV shows, restaurants, cuisines, events, activities, etc. In some implementations, the entities associated with a user can include any entity represented by a node in a knowledge graph portion, e.g., knowledge graph portions 200 and 300 illustrated in FIG. 2 and FIG. 3, respectively. In some implementations, the entities in a user's profile are derived from concepts that are of interest to the user. A concept can be a person, place, thing, or idea. Concepts that are of interest to a particular user are determined from the particular user's activity across various web properties. For example, concepts of interest can be determined from the particular user's web search history, social network information, consumed media, location history, check-ins, and other sources.

The concepts of interest are then matched with entities represented in a data source. For example, concepts of interest can be matched with entities represented by data organized in the form of a knowledge graph, as described above. Alternatively, or additionally, concepts of interest can be matched with entities represented in any database containing entity information. In some implementations, concepts of interest to the user are received from a third-party provider. For example, a third-party distribution channel for event tickets can provide common concepts of interest from the user's event ticket purchase history, for example, event types, music genres, music artists, and event locations. As a further example, a third-party content provider can provide movies as concepts of interest for the user based on the user's movie watching history. The profile data for a user can include entities that are matched with the user's concepts of interest.

Additionally, or alternatively, the profile data for a user can include preferences of the user. The preferences can reflect the user's preferences in regards to different activities in which the user can participate. For example, the preferences can include cost preferences for eating at restaurants, cuisine preferences for restaurants at which to eat, preferences for the type of activity in which to participate, and preferences for the location of activities, etc. The preferences of a user can also be determined from the user's activity across various web properties, for example, the user's web search history, social network information, consumed media, location history, check-ins, online purchase history, and other sources. For example, the user's cost preferences can be determined from the user's location history and check-in history. From the user's location history and check-in history, it can be determined what restaurants the user has visited. From this information, the user's cost preferences for eating out can be determined. As a further example, the user's music type preferences can be determined from the user's purchase history of music media.

Additionally, or alternatively, the profile data for a user can include time intervals for when the user is available. The time intervals can include the times that the user has no activities or events scheduled. For example, the available time intervals for a user can be identified from a personal information manager associated with the user. For example, the personal information manager can include web-based calendars or stand-alone calendar applications that are used to help manage time and the scheduling of events or activities. These personal information managers for users can be accessed to identify time intervals in which users have no scheduled activities or events.

In some implementations, the profile data for a particular user can include user attributes that are characteristics or inherent aspects of other users. Information regarding different users can be clustered based on the user attributes for the users. For example, information regarding users can be clustered based on a similarity between their user attributes. Different thresholds can be met to determine whether information regarding users should be clustered together. For example, information regarding users is clustered when the users share a predetermined number or proportion of user attributes. The profile data for a user in a particular cluster can include user attributes that are included in the profile data for the other users in the particular cluster. For example, the profile data for a first user does not include any user attributes related to food preferences. The first user can be clustered with a second user and third user based on the similarity between their profile data. The profile data for the second user can include “Mexican food” as a user attribute. The profile data for the third user can include “Taco Bell” as a user attribute. Therefore, “Mexican food” and “Taco Bell” can be added to the user attributes in the profile data for the first user.

The activity correlation system 402 also receives activity identifiers 406. The activity identifiers 106 identify activities in which users can participate. For example, an activity identifier can be data that represents the text “The King Tut Exhibit,” which identifies The King Tut Exhibit that can be visited by individuals. The activities can be any event that the user can participate in or specific behavior that can be performed by the user. Example activities include dinner at a restaurant, a concert, a sporting event, a movie showing, a museum exhibit, etc. The activity identifiers 406 can be received from different sources. In some implementations, the activity correlation system 402 receives activity identifiers 406 from a third-party provider. The third-party provider can be any service that contains knowledge about events or activities in which users can participate. For example, Ticketmaster is a third-party ticket and sales provider that contains information about events and activities. The activity correlation system 402 can obtain activity identifiers 406 identifying different events and activities from Ticketmaster. As a further example, OpenTable is a restaurant reservation provider that contains information about restaurant availability. The activity correlation system 402 can obtain activity identifiers 406 that identify different restaurants at which individuals can eat. In some implementations, the activity correlation system 402 receives activity identifiers 406 from a knowledge graph portion. Nodes in knowledge graph portions can represent activities, and the activity correlation system 402 can receive activity identifiers 406 that identify the activities represented by the nodes in a knowledge graph portion. In some implementations, the activity correlation system 402 can receive activity identifiers 406 from a combination of sources, for example, both knowledge graph portions and third-party provider sources.

The activities identified by activity identifiers 406 are associated with activity attributes. Activity attributes for an activity are qualities or features that are characteristics or inherent aspects of the activity. For example, activity attributes that can be associated with the activity of eating at a restaurant include the type of cuisine, e.g., Japanese or Italian, the location of the restaurant, e.g., San Francisco, the costliness of the restaurant, e.g., $20-30 a person, and the points in time that the restaurant is available, e.g., 7:00 P.M. As a further example, activity attributes that can be associated with the activity of attending The King Tut Exhibit can include information identifying the museum holding the exhibit, e.g., The Smithsonian, the topicality of the exhibit, e.g., King Tut and/or Egypt, the costliness of the exhibit, e.g., $5, and the time that the exhibit is accessible, e.g., February 14-February 28 from 10:00 A.M-6:00 P.M. The activity attributes for the activities identified by the activity attributes 406 can be identified by the source of the activity attributes 406. The source of activity identifiers 406 can contain activity attributes for the activities identified by the source. For example, Ticketmaster can contain activity attributes for a concert identified by an activity identifier from Ticketmaster, for example, the time and date of the concert, the artists performing at the concert, the music genre of the concert, the location of the concert, and the costliness of the concert. As a further example, a knowledge graph portion can contain activity attributes for an activity represented by a node in the knowledge graph. For example, nodes associated with the activity node in the knowledge graph portion can represent activity attributes.

The activity correlation score determiner 408 determines a correlation score for each activity identified by the activity identifiers 406, as described in more detail below with reference to FIGS. 5-6. The correlation score for each activity is determined from a correlation between the activity attributes for the activity and the user's profile data.

The activity notifier 410 initiates a notification process. The notification process notifies the user about the activities based on the correlation scores for the activities, as described in more detail below with reference to FIG. 5 and FIGS. 7A-7D. For example, the correlation score for an activity determines whether the activity notifier 410 notifies the user about the activity. Additionally, the correlation score for an activity can determine how the activity notifier 410 notifies the user about the activity.

FIG. 5 illustrates an example method for determining activities relevant to users. For convenience, the example method 500 will be described in reference to a system that performs method 500. The system can be, for example, the activity correlation system 402 described above with reference to FIG. 4. In some implementations, the system can be one or more computers.

The system receives profile data for a user (502). The profile data includes user attributes for the user, as described above with reference to FIG. 4. The system also receives a confidence score for each of the user attributes received. The confidence score for a user attribute indicates a level of confidence that the user attribute is associated with the user. In some implementations, the user attributes also include time intervals for when the user is available.

The system receives activity identifiers that identify activities in which the user can participate (504). Each of the activities is associated with one or more activity attributes, as described above with reference to FIG. 4. The activity attributes associated with an activity can be different qualities or features of the activity. For example, the activity attributes can include a location of the activity, a cost of the activity, a genre of the activity, and/or any information associated with the activity. Other features can be described by activity attributes. For example, activity attributes can describe one or more points in time that the activities will occur.

In some implementations, the activity identifiers are filtered. For example, the system can perform a filtering of the activity identifiers received by the system. As a further example, a first set of activity identifiers can be filtered to generate a second set of activity identifiers. The system receives the second set of activity identifiers. Different filtering methods can be used. An example filtering method is to filter the activity identifiers so that the activity identifiers received by the system identify only activities that are geographically located within a predetermined distance from a geographic location associated with the user. The geographic location of an activity can be identified by an activity attribute associated with the activity that describes the geographic location of the activity. For example, the activity attributes for a meal at The French Laundry can include “Yountville,” the city location of the restaurant. The location of the activity is compared to the geographic location of the user. The geographic location of the user can be identified from different sources. For example, the location of the user can be identified from the user's profile data. The user's profile data can include a user attribute that describes the location of the user's home, e.g., “San Francisco.” Alternatively, or additionally, the user's geographic location can be identified from the user's location history. For example, the user's location history can be analyzed to determine a location that is most associated with the user, e.g., the location most frequented by the user. Alternatively, or additionally, the user's geographic location can be identified from the geolocation of the user's device. For example, the geolocation of the user's device can be determined from an IP address or GPS signal of the user's device. If the location of the activity is within a predetermined distance, e.g., 20 miles, from the location of the user, then the system can receive an activity identifier for the activity.

An additional example filtering method is to filter the activity identifiers so that the activity identifiers received by the system identify only activities that are associated with activity attributes that correlate with user attributes. In some implementations, an activity attribute is determined to correlate with a user attribute if the activity attribute is the same as the user attribute. For example, the user attribute “Japanese restaurant” is correlated with the activity attribute “Japanese restaurant.” In some implementations, an activity attribute is determined to correlate with a user attribute from a similarity between the activity attribute and user attribute. The similarity can be based on the similarity between the words and/or letters that identify the activity attribute and user attribute. For example, the user attribute “Japan restaurant” has a higher degree of similarity with activity attribute “Japanese restaurant” than “Chinese restaurant.” An activity attribute is determined to correlate with a user attribute if the degree of similarity satisfies, for example, meets or exceeds, a threshold level of similarity. The activity identifiers can be indexed in a database by the activity attributes associated with the activities identified by the activity identifiers. The user attributes can be used to look-up the activity identifiers in the database that are associated with activity attributes that correlate with the user attributes.

The system determines a correlation score for each of the activities (506). The correlation score for a particular activity is determined from a correlation between the activity attributes for the particular activity and the profile data for the user. The correlation between the activity attributes for the particular activity and the profile data for the user is based on the correlation of each of the activity attributes with the individual user attributes included in the profile data. The system correlates activity attributes with user attributes, as described above.

The system determines that time related user and activity attributes correlate if the times reflected by the user attribute and activity attribute overlap. The profile data for a user can include user attributes that describe one or more time intervals when the user is available, as described above. The activity attributes for an activity can include one or more points in time that the user can participate in the activity. The system determines whether the one or more points in time that the activity occurs coincides partially or wholly with the time intervals for when the user is available. For example, if the user attributes for the user includes February 15 @ 6-10 P.M. as an available time interval and the activity attributes for a particular attribute includes February 15 @ 7:00 P.M. as the point in time that the activity will occur, then the system determines that the activity attribute and user attribute coincide. Therefore, the system determines that the activity attribute for the point in time that the activity occurs correlates with the user attribute for the user's available time interval.

The correlation score for a particular activity is determined from the confidence scores for the user attributes that are determined to correlate with the activity attributes for the particular activity. In some implementations, the correlation score can be determined from a combination of the confidence scores for the correlated user attributes. For example, the confidence scores can be combined according to a linear function, for example, a multiplicative or additive function. In some implementations, the correlation score can be determined from a weighted combination of the confidence scores for the correlated user attributes. For example, each confidence score for a user attribute that correlates with an activity attribute can be weighted by a factor. The weighted confidence scores can then be combined according to a linear function, for example, a multiplicative or additive function. The weight for a confidence score can be specific to the user attribute. The weight specific to a particular user attribute can be a measure of how much the confidence score for the particular user attribute should be weighted when determining the confidence score for an activity. For example, some user attributes can be more important in determining the correlation scores for activities. An example of an important user attribute is “vegetarian.” Another example of an important user attribute is the user's cost preferences. The confidence scores for such user attributes will be weighted heavier than confidence scores for user attributes that are less important in determining the correlation scores for an activity. In some implementations, the weights specific for user attributes can be user rated. In some implementations, a machine learning system trained using conventional techniques can determine the weights.

The system initiates a notification process that notifies the user about one or more of the activities based on the correlation scores for the one or more activities (508). The system selects the activities about which to notify the user based on the correlation scores determined for the activities. In some implementations, the system notifies the user about a predetermined number of activities with the greatest correlation scores. In some implementations, the system determines the activities that have correlation scores that satisfy, for example, meet or exceed, a predetermined correlation score threshold. The system notifies the user about the activities with correlation scores that satisfy the threshold. In some implementations, the system notifies the user about a predetermined number of activities with correlation scores that satisfy a predetermined correlation score threshold.

In some implementations, notifying the user about the activities includes scheduling the activities on the calendar associated with the user. For example, the system causes a calendar event to be created for the activity on the web-based calendars or stand-alone calendar applications that the user uses to help manage the user's time and the scheduling of events or activities. The calendar event can be scheduled for the point in time that the activity is to occur on the calendar.

In some implementations, notifying the user about the activities includes presenting a graphical user interface on a display screen of the user's client device. The graphical user interface can include one or more notification objects. The one or more notification objects describe the activities that the system has selected to notify the user about, as described in more detail below with reference to FIGS. 7A-7D. In some implementations, each activity can be represented by one notification object. The notification objects can be presented in an order based on the correlation scores for the activities represented by the notification objects. For example, the first notification object presented to the user can describe the activity with the greatest correlation score and the last notification object presented to the user can described the activity with the lowest correlation score. In some implementations, a notification object can describe more than one activity. The activities described in a notification object can also be presented in an order based on the activity correlation scores, as described above.

The notification objects can include text describing the activities. For example, the notification object for a particular activity can include the name of the particular activity and the point in time that the particular activity will take place. If the system has scheduled the activity on the calendar associated with the user as described above, the notification object for the activity can also include text that describes that the activity has been scheduled on the user's calendar. The notification objects can also include links to distribution channels from where the user can perform the necessary actions to participate in the activities. The system can receive an interaction with a presented link at the client device from the user. For example, the user can interact with a user interface device, e.g., a keyboard, mouse, or touch sensitive display for input, of the client device to interact with the link. In response to the received interaction, the system opens a web browser on the user's client device. The system then sends a webpage associated with the distribution channel referenced by the link to the web browser. For example, for a meal activity at a restaurant, the notification object for the activity can include a link to a reservation service, e.g., OpenTable, from which the user can reserve the activity. As a further example, for a concert activity, the notification object for the activity can include a link to a ticket purchasing service, e.g., Ticketmaster, from which the user can purchase tickets for the concert. In some implementations, in response to the received interaction, the system causes the user's client device to run an application associated with the distribution channel referenced by the link. In some implementations, the system can schedule the activity for the user. For example, the notification object for an activity can include links that allow the user to schedule the activity or dismiss the notification object. When the system receives an interaction with the link to schedule the activity, the system can schedule the activity on the calendar associated with the user. Furthermore, if additional action is needed for the user to participate in the activity, e.g., making a restaurant reservation or purchasing concert tickets, the system can perform the actions. For example, the system can access a reservation service to make a reservation for the user or access a ticket purchasing service to purchase concert tickets for the user.

In some implementations, the correlation score for activities may not reflect a correlation between the one or more points in time that the activities will occur and the time intervals that the user is available. For example, if the profile data for the user does not include time intervals for when the user is available, then the correlation score does not reflect a correlation between the occurrences of the activity with the user's available time. Additionally, or alternatively, if the activity attributes for activities do not include the points in time that the activities will occur, then the correlation score does not reflect a correlation between the occurrence of the activity with the user's available times. In such implementations, the system identifies when the user is available. For example, the system identifies time intervals that the user is available from a calendar associated with the user, as described above. The system selects activities that occur at points in time that coincide with the time intervals that the user is available. For example, the system selects a sporting event activity because it will occur at 7 P.M. on February 14, which falls within the user's available time interval of 5 P.M.-10 P.M. on February 14. The system then notifies the user about one or more of the selected activities, as described above.

FIG. 6 illustrates an example correlation between activity attributes associated with activities and the profile data for a user. For convenience, the figure will be described in reference to a system that determines the correlation. The system can be, for example, the activity correlation system 402 described above with reference to FIG. 4. In some implementations, the system can be one or more computers.

FIG. 6 illustrates profile data for a user 602. The profile data 602 includes of list of user attributes. Each user attribute is associated with a confidence score, as illustrated by the numerical values in the parentheses. FIG. 6 additionally illustrates two different activities. The Activity 1 604 is a meal at The French Laundry and the Activity 2 606 is a Los Angeles Lakers vs. Miami Heat game. Both Activity 1 604 and Activity 2 606 include a list of activity attributes that describe the respective activities. The system determines a correlation between the activity attributes for Activity 1 604 and Activity 2 606 with the user attributes included in the profile data 602, as described above with reference to FIG. 5. The lines between activity attributes and user attributes indicate the correlations between activity attributes and user attributes as determined by the system.

The system determines a correlation score for Activity 1 604 from the confidence scores for the user attributes that correlate with the activity attributes of Activity 1 604. “Per se,” “Tasting Menu,” “Foie gras,” “Yountville,” and “February 14 @ 8-10 P.M.” are the user attributes that correlate with the activity attributes of Activity 1 604. The respective confidence scores, i.e., 0.8, 0.4, 0.6, 0.4, and 1, can be combined according to a linear function. For example, the confidence scores can be added, which results in a confidence score of 3.2 for Activity 1 604. In some implementations, each of the confidence scores can be additionally weighted, as described above with reference to FIG. 5.

The system determines a correlation score for Activity 2 606 from the confidence scores for the user attributes that correlate with the activity attributes of Activity 2 606. “Basketball,” “Los Angeles,” “Kobe Bryant,” “Lebron James,” and “February 15 @ 7:00 P.M.” are the user attributes that correlate with the activity attributes of Activity 2 606. A combination of the respective confidence scores, i.e., 0.7, 0.2, 0.4, 0.3, and 1, can be combined according to a linear function. For example, the confidence scores can be added, which results in a confidence score of 2.6 for Activity 2 606. In some implementations, each of the confidence scores can be additionally weighted, as described above with reference to FIG. 5.

FIGS. 7A-7D illustrate example graphical user interfaces for notifying users about relevant activities. In FIGS. 7A-7D, a system, for example the activity correlation system 402 described above with reference to FIG. 4, notifies a user about two activities based on the correlation scores for the activities, as described above. The first activity is for a Los Angeles Lakers vs. Miami Heat game and the second activity is for a meal at The French Laundry. The system causes a graphical user interface to be presented on a display screen 704 on the user's client device 702. The graphical user interface includes a first notification object 706 and a second notification object 708. The notification objects are presented in an order based on the correlation scores for the activities represented by the notification objects. In FIG. 7A, the first notification object 706 is presented in the forefront of the second notification object 708 if the activity represented by the first notification object 706 has a greater correlation score than the activity represented by the second notification object 708. The first notification object 706 describes the first activity and includes text describing the first activity, “Los Angeles Lakers vs. Miami Heat Game.” The first notification object 706 can include additional activity attributes that describe the first activity. For example, the first notification object 706 additionally includes text describing the point in time that the activity will occur, “February 15 @ 7:00 P.M.” The first notification object 706 can also include links to distribution channels from which the user can obtain tickets for the first activity. For example, the first notification object 706 includes the anchor text “Ticketmaster” that links the user to the Ticketmaster website, from which the user can purchase tickets for the Los Angeles Lakers vs. Miami Heat game. The user can cause the second notification object 708 to be brought to the forefront. For example, the user can select the second notification object 708 by tapping on the portion of the display screen 704 that displays the second notification object 708.

In response to the user interaction with the second notification object 708, the system causes the second notification object 708 to be displayed in the forefront of the first notification object 706, as illustrated in FIG. 7B. The second notification object 708 describes the second activity and includes text describing the second activity, “The French Laundry.” The second notification object 708 can include additional activity attributes that describe the second activity. For example, the second notification object 708 additionally includes text describing the point in time that the activity can occur, “February 14 @ 8:00 P.M.” The second notification object 708 can also include links to distribution channels from which the user can make a reservation for the activity. For example, the second notification object 708 includes the anchor text “OpenTable” that links the user to the OpenTable website, from which the user can make a reservation at The French Laundry for February 14 @ 8:00 P.M.

In some implementations, the system causes activities to be scheduled on a calendar associated with the user, as described above with reference to FIG. 5. In such implementations, the system notifies the user about the scheduling, as illustrated in FIG. 7C. The first notification object 710 describes the first activity and includes text describing the first activity, “Los Angeles Lakers vs. Miami Heat Game.” The second notification object 712 describes the second activity and includes text describing the second activity, “The French Laundry.” The activity described by the first notification object 710 was scheduled on the calendar associated with the user. The first notification object 710 can include text that describes the scheduling, for example, “This event has been scheduled on your calendar.”

In some implementations, the user can cause the system to schedule activities on a calendar associated with the user from a notification object. Additionally, the user can cause the system to perform any additional actions for the user to participate in the activity, as described above with reference to FIG. 5. In such implementations, the system notifies the user about the activity, as illustrated in FIG. 7D. The first notification object 714 describes the first activity and includes text describing the first activity, “Los Angeles Lakers vs. Miami Heat Game.” The second notification object 712 describes the second activity and includes text describing the second activity, “The French Laundry.” The first notification object 714 can include links that when selected, cause the system to schedule the first activity on the user's calendar and perform additional actions so that the user can participate in the first activity. For example, the first notification object 714 includes the text “Schedule and purchase tickets.” When selected by the user, the system schedules the first activity on the user's calendar and causes the system to purchase tickets for the Los Angeles Lakers vs. Miami Heat game for the user.

An electronic document, which for brevity will simply be referred to as a document, may, but need not, correspond to a file. A document may be stored in a portion of a file that holds other documents, in a single file dedicated to the document in question, or in multiple coordinated files.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of the implementations or on the scope of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

No element, act, or instruction used in the present application should be construed as critical or essential to the disclosed implementations unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

1. A method comprising:
receiving, by one or more computer devices, profile data for a user,
the profile data including user attributes,
the profile data including information regarding time intervals during which the user is available;
receiving, by the one or more computer devices, a plurality of activity identifiers that identify activities in which the user can participate,
each of the activities being associated with activity attributes,
the activity attributes identifying one or more points in time at which the activity will occur;
determining, by the one or more computer devices, a correlation score for each activity of the activities,
the correlation score for the activity being determined from a correlation between the activity attributes associated with the activity and the profile data for the user; and
notifying, by the one or more computer devices, the user about one or more of the activities based on the correlation scores for the one or more activities.

2. The method of claim 1, further comprising:
determining that the one or more points in time at which the activity will occur coincide with the time intervals.

3. The method of claim 1, further comprising:
determining a confidence score for each of the user attributes,
where determining the correlation score for each activity comprises:
determining the correlation score from the confidence scores for the user attributes that correlate with one or more of the activity attributes associated with the activity.

4. The method of claim 1, further comprising:
determining that the correlation score for each of the one or more activities satisfies a threshold.

5. The method of claim 1, where notifying the user about the one or more activities comprises:
providing, for presentation, one or more notification objects,
the one or more notification objects identifying the one or more activities in an order based on the correlation score for each of the one or more activities.

6. The method of claim 1, where notifying the user about the one or more activities comprises:
automatically scheduling the one or more activities in a calendar associated with the user.

7. A system comprising:
one or more computers to:
receive profile data for a user,
the profile data including user attributes identifying entities of interest to the user;
receive a plurality of activity identifiers that identify activities in which the user can participate,
each of the activities being associated with one or more activity attributes;
determine a correlation score for each activity of the activities,
the correlation score for the activity being determined from a correlation between the one or more activity attributes associated with the activity and the profile data for the user;
select one or more of the activities that occur at points in time during which the user is available; and
notify the user about the selected one or more activities based on the correlation scores for the selected one or more activities.

8. The system of claim 7, where the one or more computers, when selecting one or more of the activities that occur at points in time during which the user is available, are to:
identify time intervals during which the user is available from a calendar associated with the user; and
select the one or more activities that occur at points in time that coincide with the time intervals.

9. The system of claim 7, where the one or more computers are further to:
receive a confidence score for each of the user attributes,
where the one or more computers, when determining the correlation score for each activity, are to:
determine the correlation score from the confidence scores for the user attributes that correlate with one or more of the activity attributes associated with the activity.

10. The system of claim 7, where the one or more computers are further to:
determine that the correlation score for each of the one or more activities satisfies a threshold.

11. The system of claim 7, where the one or more computers, when notifying the user about the selected one or more activities, are to:
provide, for presentation, one or more notification objects,
the one or more notification objects identifying the selected one or more activities in an order based on the correlation score for each of the selected one or more activities.

12. The system of claim 7, where the one or more computers, when notifying the user about the selected one or more activities, are to:
schedule the selected one or more activities on a calendar associated with the user.

13. The system of claim 7, where the one or more computers, when notifying the user about the selected one or more activities, are to:
present, for display, a notification object describing one of the selected one or more activities,
the notification object including an option for creating an entry, in a calendar associated with the user, relating to the one of the selected one or more activities, and
create the entry in the calendar based on selection of the option.

14. A computer storage medium storing instructions, the instructions comprising:
a plurality of instructions which, when executed by one or more processors, cause the one or more processors to:
receive profile data for a user,
the profile data including user attributes,
the profile data including information regarding time intervals during which the user is available;
receive a plurality of activity identifiers that identify activities in which the user can participate,
each of the activities being associated with activity attributes,
the activity attributes identifying one or more points in time at which the activity will occur;
determine a correlation score for each activity of the activities,
the correlation score for the activity being determined from a correlation between the activity attributes associated with the activity and the profile data for the user; and
notify the user about one or more of the activities based on the correlation scores for the one or more activities.

15. The computer storage medium of claim 14, where the plurality of instructions, when executed by the one or more processors, further cause the one or more processors to determine that the one or more points in time at which the activity will occur coincide with the time intervals.

16. The computer storage medium of claim 14, wherein the plurality of instructions, when executed by the one or more processors, further cause the one or more processors to determine a confidence score for each of the user attributes,
where one or more instructions, of the plurality of instructions, to determine the correlation score for each activity include:
one or more instructions to determine the correlation score from the confidence scores for the user attributes that correlate with one or more of the activity attributes associated with the activity.

17. The computer storage medium of claim 14, where the plurality of instructions, when executed by the one or more processors, further cause the one or more processors to determine that the correlation score for each of the one or more activities satisfies a threshold.

18. The computer storage medium of claim 14, where one or more instructions, of the plurality of instructions, to notify the user about the one or more activities include:
one or more instructions to present, for display, one or more notification objects,
the one or more notification objects identifying the one or more activities in an order based on the correlation score for each of the one or more activities.

19. The computer storage medium of claim 14, where one or more instructions, of the plurality of instructions, to notify the user about the one or more activities include:
one or more instructions to schedule the one or more activities in a calendar associated with the user.

20. The computer storage medium of claim 14, where the plurality of instructions, when executed by the one or more processors, further cause the one or more processors to:
identify the time intervals during which the user is available from a calendar associated with the user; and
select at least one of the one or more activities for which the activity attributes identify a point in time that coincides with the time intervals.
